(19) United States
(12) Patent Application Publication
(10) Pub. No.: US 2006/0105793 A1
(43) Pub. Date: May 18, 2006

(54) Broadcast message services for communication devices engaged in push-to-talk communication

(76) Inventors: Gerald J. Gutowski, Chicago, IL (US); Anthony J. Dolezal, Barrington, IL (US)

Correspondence Address: MOTOROLA INC, 600 NORTH US HIGHWAY 45, ROOM AS437, LIBERTYVILLE, IL, 60048-5343, US

(21) Appl. No.: 10/987,287

(22) Filed: Nov. 12, 2004

(51) Int. Cl. H04B 7/00

(52) U.S. Cl. 455/518

(57) ABSTRACT

A method (200) and an apparatus (700) for a wireless communication network (102) for providing a broadcast message to a group of wireless communication devices (104, 106, 108) engaged in a push-to-talk (“PTT”) communication are provided. The wireless communication network (102) receives (204) broadcast information from a priority entity (118), processes (206) the broadcast information into the broadcast message, preempts (208) floor control of the PTT communication of the group of wireless communication devices, take a floor control (210) of the PTT communication, and transmits the broadcast message to all (212) or to a target group (602) of wireless communication devices.

### FIELD OF THE INVENTION

The present invention generally relates to broadcast message services, and more specifically, to a wireless communication network providing broadcast services to wireless communication devices engaged in a push-to-talk communication.

### BACKGROUND OF THE INVENTION

In a wireless communication network, such as a cellular telephone network, a broadcast message, such as a short message service (“SMS”) message, a cell broadcast service (“CBS”) message, and a Multimedia Broadcast and Multimedia Service (“MBMS”) message, can be transmitted from a base station to wireless portable communication devices that are registered to the base station. Generally, a user subscribes to a service provider for messages that provide information of his choice, such as news, sports, stock quotes, and others alike, and receives messages containing information of his choice from the service provider. However, there is no requirement to subscribe to any broadcast message service, and those wireless portable communication devices without subscription may ignore all broadcast messages. Further, when the wireless portable communication devices receive the broadcast message, the subscribed users may choose to view and/or listen to the received broadcast message now or later. For example, in a push-to-talk (“PTT”) communication involving a group of communication devices, one of the communication devices engaged in the PTT communication controls the floor, such that only the information from the communication device holding the floor control is received by all other devices, and the broadcast message would not be communicated in the current PTT communication. Further, the group of users engaged in the PTT communication may be reluctant to leave the PTT communication to check the broadcast message just received. However, this capability of allowing the users to delay accessing the received broadcast message can be detrimental to the users' interest in some circumstances. In emergency or time critical situations, such as a traffic accident, traffic jam, severe weather, fire, crime, terrorist attacks, bomb threats, national security alerts, or other situations alike, it would be in the users' and the public's best interest to receive and access a message regarding the emergency as soon as the message is received at the device. For example, if a severe weather condition, such as a tornado, has just developed in the area where a user is located and a local base station transmits an emergency broadcast message notifying of the tornado in the area, it would be in the user's best interest to receive and view the message as soon as it is received. In other situations such as in a case of a missing person or kidnapping, it is desirable, or may be critical, to notify as soon as possible people in a relevant area such as a city where the missing or kidnapped person was last seen. Under emergency or time critical situations such as those described above, it is desirable to have the received emergency message communicated as soon as the emergency message is received.

### BRIEF DESCRIPTION OF THE DRAWINGS

FIG. 1 is a block diagram of an environment where at least one of preferred embodiments may be practiced;

FIG. 2 is an exemplary flowchart for providing a broadcast message to a group of wireless communication devices engaged in a push-to-talk communication in accordance with at least one of the preferred embodiments;

FIG. 3 is an exemplary flowchart further illustrating a process of receiving emergency information from a priority entity in accordance with at least one of the preferred embodiments;

FIG. 4 is a block diagram of an emergency environment where at least one of preferred embodiments may be practiced;

FIG. 5 is an exemplary flowchart for an emergency situation further illustrating the processing of the broadcast information for identifying a target group of wireless communication devices based upon the target group information contained in the broadcast information received in accordance with at least one of the preferred embodiments;

FIG. 6 is an exemplary flowchart further illustrating the process of transmitting the broadcast message to the group of wireless communication devices based upon the target group information; and

FIG. 7 is an exemplary block diagram of a wireless communication network for transmitting a broadcast message to a group of wireless communication devices engaged in a push-to-talk communication in accordance with at least one of the preferred embodiments.

### DETAILED DESCRIPTION OF THE PREFERRED EMBODIMENTS

A wireless communication network capable of supporting push-to-talk (“PTT”) communications, such as a push-to-talk communication over a cellular telephone network, receives information from a priority entity while holding a PTT communication among groups of wireless communication devices. The wireless communication network identifies each wireless communication device involved in the push-to-talk communication, assumes floor control of the PTT communication, interrupts current PTT communication, and transmits a broadcast message to the group or groups of wireless communication devices. The wireless communication network may further determine the location of each wireless communication device involved in the PTT communication, and transmit the broadcast message only to those wireless communication devices located within areas relevant to the broadcast message. For example, if the broadcast message was an emergency broadcast message affecting only a certain area, then the broadcast message may be only sent to those wireless communication devices located within or near the certain area affected by the emergency.

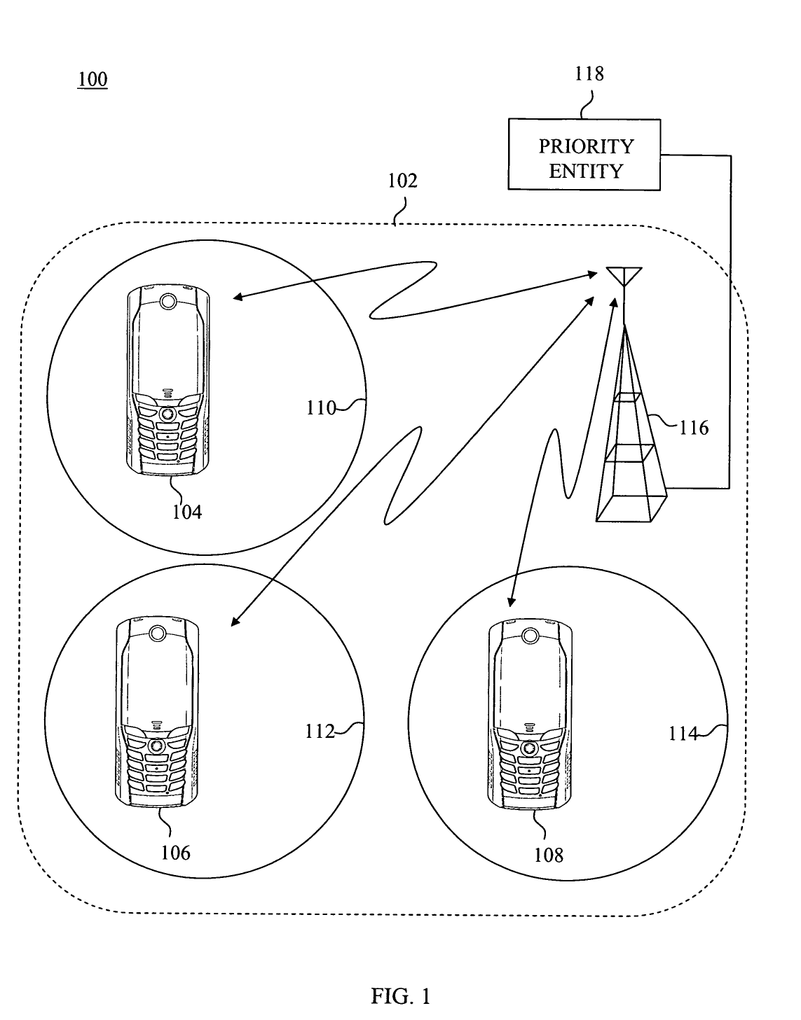

FIG. 1 is a block diagram 100 of an environment where at least one of preferred embodiments may be practiced. A wireless communication network 102 has a group of wireless communication devices engaged in a push-to-talk communication. For simplicity, only three wireless communication devices, first, second, and third wireless communication devices 104, 106, and 108, respectively, are shown as the group of wireless communication devices in FIG. 1. Each wireless communication device is located within a corresponding area, first 110, second 112, and third 114, respectively, and is served by a base station 116, which is another component of the wireless communication network 102. Although only one base station 116 is shown to serve all areas, each area may be served by a separate base station in the wireless communication network 102. Further, the wireless communication network 102 may concurrently support more than one PTT communication sessions among a plurality of groups of wireless communication devices. A priority entity 118 communicates broadcast information to the wireless communication network 102, and the wireless communication network 102 transmits a broadcast message containing the broadcast information through the base station 116 to some or all of the wireless communication devices involved in the push-to-talk communication.

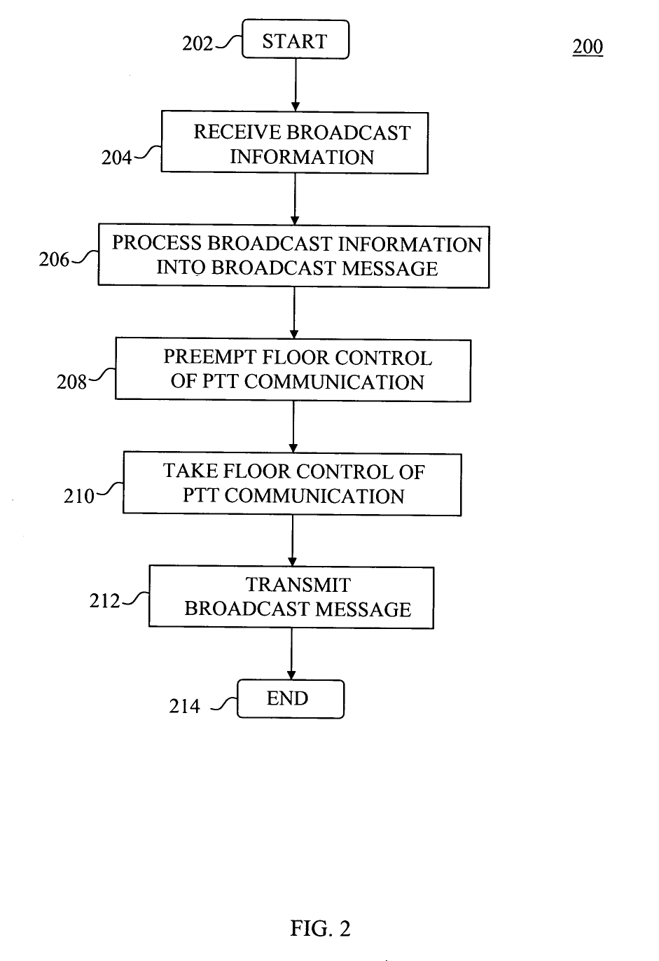

FIG. 2 is an exemplary flowchart 200 for a wireless communication network 102 for providing a broadcast message to a group of wireless communication devices 104, 106, and 108 engaged in a PTT communication in accordance with at least one of the preferred embodiments. The process begins in block 202, and the wireless communication network 102 receives broadcast information from a priority entity 118 in block 204. The priority entity 118 has a priority usage right over the PTT communication, and is capable of interrupting the current session of the PTT communication in the wireless communication network 102. The wireless communication network 102 processes the received broadcast information in block 206 into the broadcast message to be transmitted. In block 208, the wireless communication network 102 preempts a floor control of the PTT communication, and takes the floor control of the PTT communication in block 210. The wireless communication network 102 transmits the broadcast message to the group of wireless communication devices 104, 106, and 108 in block 212. The broadcast message may take various formats including formats compatible with a broadcast mode of a Multimedia Broadcast and Multimedia Service, a multicast mode of a Multimedia Broadcast and Multimedia Service, a Short Message Service, and an Emergency Alert System. The wireless communication network 102 may re-establish the interrupted PTT communication among the group of wireless communication devices after transmitting the emergency broadcast message. The process ends in block 214.

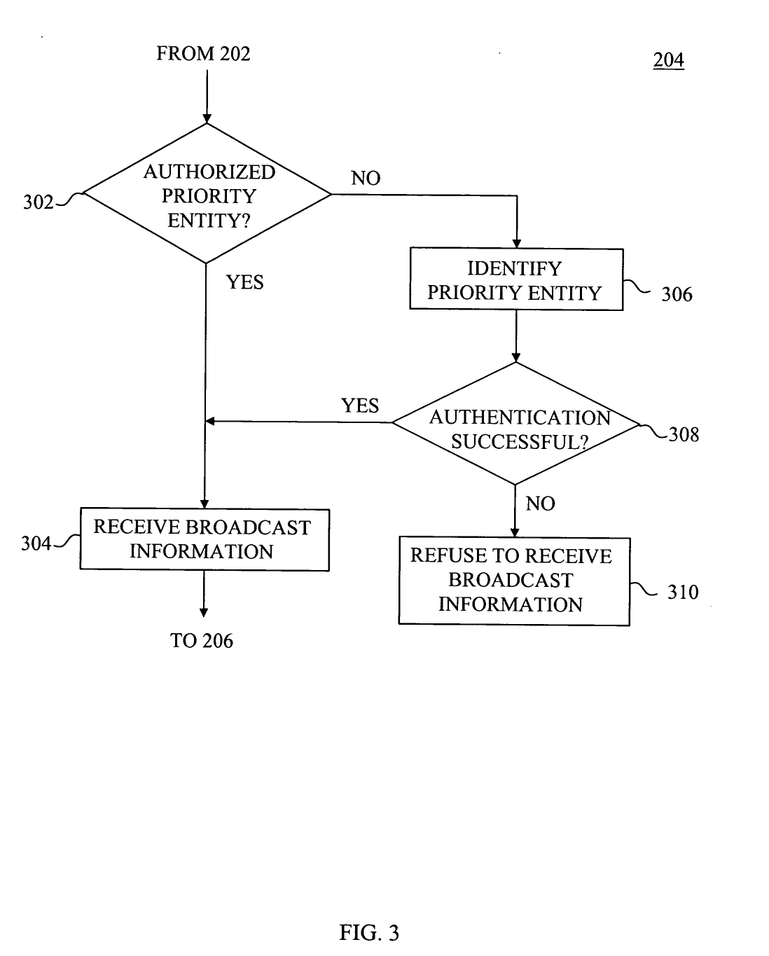

FIG. 3 is an exemplary flowchart further illustrating a process of receiving broadcast information from the priority entity 118 of block 204 in accordance with at least one of the preferred embodiments. The wireless communication network 102 may receive the broadcast information from various sources. In block 302, the wireless communication network 102 determines whether the priority entity 118 is an authorized source. The authorized source may include governmental agencies, police, fire department, weather service and other agencies which have existing agreement and authorization with the wireless communication network 102. If the priority entity 118 is an authorized source, then the wireless communication network 102 proceeds to receive the broadcast information from the priority entity 118 in block 304. However, if the wireless communication network 102 determines that the priority entity 118 is not an authorized source, such as a source having no existing agreement or authorization with the wireless communication network 102, then the wireless communication network 102 identifies, or attempts to identify, the priority entity 118 in block 306, and authenticates, or attempts to authenticate, the priority entity 118 in block 308. If the authentication of the priority entity 118 is successful, then the wireless communication network 102 proceeds to receive the broadcast information from the priority entity 118 in block 304. However, if the authentication of the priority entity 118 is unsuccessful, then the wireless communication network 102 refuses to receive the broadcast information from the priority entity 118 in block 310.

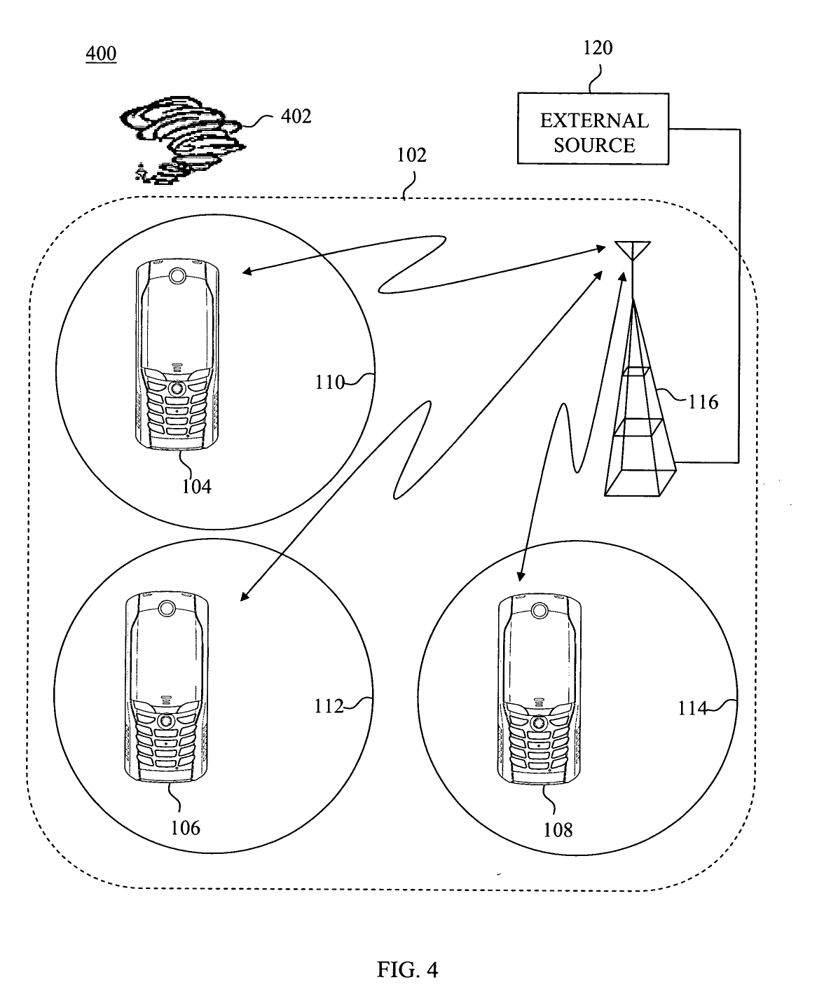

The broadcast information received in block 204 of FIG. 2 may further contain target group information, which identifies wireless communication devices relevant to the broadcast information within the group of wireless communication devices 104, 106, and 108. The target group information may be various classifications including, but not limited to, a geographical area relevant to the broadcast information for an emergency, a user interest group, work-related group, a fan club, or any other group classifications that may be used to identify sub-group of wireless communication devices within the group of wireless communication devices. The wireless communication network 102 may extract the target group information from the broadcast information, form a target group of wireless communication devices based upon the target group information, and transmit the broadcast message only to the target group of wireless communication devices. For example, in FIG. 4, a tornado 402 is shown to be approaching the first service area 110 where the first wireless communication device 104 is located. It is, therefore, critical for the wireless communication network 102 to notify the first wireless communication device 104 of the emergency. However, if each of the second and third service areas 112 and 114 is located away from the first service area 110 by a significant distance, then there is no immediate emergency for the second and third service areas 112 and 114. In this example, the target group information may include information regarding affected areas based on the tornado 402.

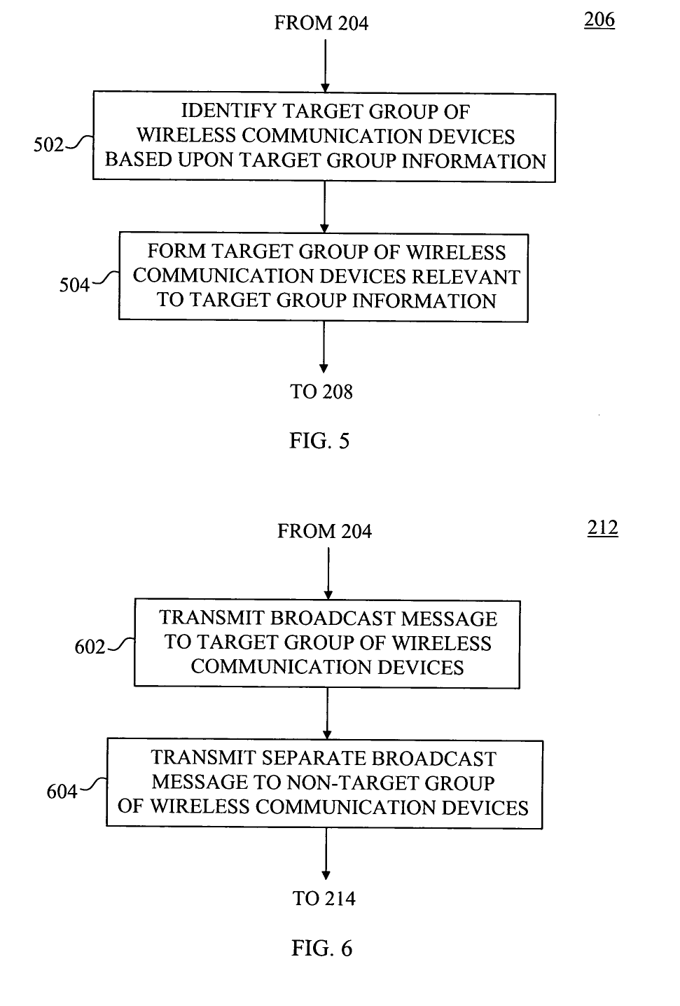

FIG. 5 is an exemplary flowchart for such an emergency situation further illustrating the processing of the broadcast information of block 206 for identifying a target group of wireless communication devices based upon the target group information contained in the broadcast information received in block 204 in accordance with at least one of the preferred embodiments. In block 502, the wireless communication network 102 identifies a target group of wireless communication devices relevant to the broadcast information based upon the target group information within the group of wireless communication devices. The wireless communication network 102 then forms a target group of wireless communication devices in block 504. Instead of transmitting the broadcast message, which in this case is an emergency broadcast message due to the tornado 402, to all wireless communication devices engaged in the current PTT communication, the wireless communication network 102 may transmit the broadcast message only to the target group of wireless communication devices which are located within the affected or potentially affected areas by the tornado 402. The wireless communication network 102 may transmit a different message to the wireless communication devices not belonging to the target group of wireless communication devices. In this example, the affected or potentially affected area relevant to the target information would include the first service area 110. Because the emergency is localized in this example of the approaching tornado 402, the target group information would include information regarding affected or potentially affected areas due to the tornado 402. The first wireless communication device 104 would then be identified as a member of the target group because it is located within the affected area, which is the first service area 110, by the tornado 402. FIG. 6 is an exemplary flowchart further illustrating block 212 of transmitting the broadcast message to the group of wireless communication devices based upon the target group information. In block 602, the broadcast message, such as “TORNADO APPROACHING SEEK SHELTER IMMEDIATELY,” would be transmitted only to the target group of wireless communication devices, which in this example is only the first wireless communication device 104. A different message, such as “YOUR SESSION HAS BEEN INTERRUPTED DUE TO A WEATHER EMERGENCY AFFECTING MEMBERS IN YOUR GROUP,” may be transmitted to all other wireless communication devices engaged in the PTT communication, which in this example are the second and third wireless communication devices 106 and 108 in block 604.

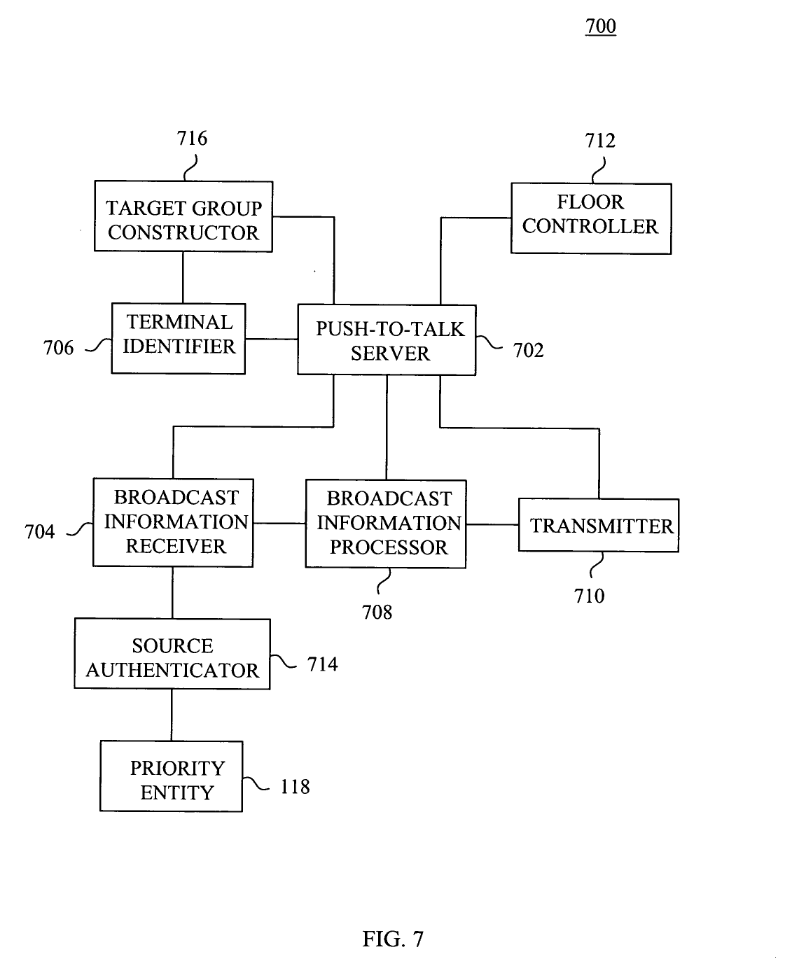

FIG. 7 is an exemplary block diagram 700 of a wireless communication network 102 for transmitting a broadcast message to a group of wireless communication devices engaged in a push-to-talk communication in accordance with at least one of the preferred embodiments. The wireless communication network 102 has a push-to-talk server 702 configured to support the push-to-talk communication among the group of wireless communication devices, such as the first, second, and third wireless communication devices 104, 106, and 108 previously illustrated. A broadcast information receiver 704 and a terminal identifier 706 are coupled to the push-to-talk server 702. The broadcast information receiver 704 is configured to receive broadcast information, and the terminal identifier is configured to identify the group of wireless communication devices. The broadcast information may include target group information, which identifies wireless communication devices relevant to the broadcast information within the group of wireless communication devices 104, 106, and 108. The target group information may be various classifications including, but not limited to, a geographical area relevant to the broadcast information for an emergency, a user interest group, work-related group, a fan club, or any other group classifications that may be used to identify sub-group of wireless communication devices within the group of wireless communication devices. A broadcast information processor 708 is coupled to both the push-to-talk server 702 and the broadcast information receiver 704, and is configured to process the broadcast information into the broadcast message. A transmitter 710 is coupled to both the push-to-talk server 702 and the broadcast information processor 708, and is configured to transmit the broadcast message to the group of wireless communication devices. The broadcast message may be various formats including formats compatible with any one of a broadcast mode of a Multimedia Broadcast and Multimedia Service, a multicast mode of a Multimedia Broadcast and Multimedia Service, a Short Message Service, and an Emergency Alert System. A floor controller 712 is coupled to the push-to-talk server 702, and is configured to take floor control of the push-to-talk communication. The floor controller 712 may be further configured to re-establish the interrupted push-to-talk communication among the group of wireless communication devices after the broadcast message is transmitted. The wireless communication network 102 also has a source authenticator 714 coupled to the broadcast information receiver 704, and is configured to determine whether an external source, such as the priority entity 118 which is connected to the source authenticator 714 and provides the broadcast information, is an authorized source. A target group constructor 716 is coupled to the terminal identifier 706 and to the push-to-talk server 702 and is configured to form a target group of wireless communication devices within the group of wireless communication devices based upon the target group information contained in the broadcast information. The transmitter 710 may be further configured to transmit the broadcast message only to the target group of wireless communication devices, and to transmit a separate broadcast message to a non-target group wireless communication devices of the group of wireless communication devices.

While the preferred embodiments of the invention have been illustrated and described, it is to be understood that the invention is not so limited. Numerous modifications, changes, variations, substitutions and equivalents will occur to those skilled in the art without departing from the spirit and scope of the present invention as defined by the appended claims.

What is claimed is:

1. A method in a wireless communication network for providing a broadcast message to a group of wireless communication devices engaged in a push-to-talk communication, the method comprising:
receiving broadcast information from a priority entity having a priority usage right over the push-to-talk communication;
processing the broadcast information into the broadcast message;
preempting a floor control of the push-to-talk communication of the group of wireless communication devices;
taking the floor control of the push-to-talk communication, and
transmitting the broadcast message to the group of wireless communication devices.

2. The method of claim 1, wherein the broadcast information includes target group information identifying wireless communication devices relevant to the broadcast information within the group of wireless communication devices.

3. The method of claim 2, wherein processing the broadcast message to the group of wireless communication devices includes:
forming a target group of wireless communication devices based upon the target group information.

4. The method of claim 3, wherein transmitting the broadcast message to the group of wireless communication devices includes:
transmitting the broadcast message to the target group of wireless communication devices.

5. The method of claim 4, wherein transmitting the broadcast message to the group of wireless communication devices includes:
transmitting a separate broadcast message to wireless communication devices of the group of wireless communication devices not belonging to the target group of wireless communication devices.

6. The method of claim 1, further comprising:
re-establishing the push-to-talk communication among the group of wireless communication devices after transmitting the broadcast message.

7. The method of claim 1, wherein the priority entity is a pre-authorized external source permitted to provide the broadcast information.

8. The method of claim 1, wherein receiving the broadcast information includes:
identifying the priority entity;
authenticating the priority entity; and
receiving the broadcast information from the priority entity after the priority entity is authenticated.

9. The method of claim 1, wherein the broadcast message is in a format compatible with at least one of:
a broadcast mode of a Multimedia Broadcast and Multimedia Service;
a multicast mode of a Multimedia Broadcast and Multimedia Service;
a Short Message Service; and
an Emergency Alert System.

10. A method in a wireless communication network for providing an emergency broadcast message to a group of wireless communication devices engaged in a push-to-talk communication, the method comprising:
receiving emergency information, the emergency information including a specified geographical area relevant to the emergency information;
processing the emergency information into the emergency broadcast message;
identifying the group of wireless communication devices;
determining location of each wireless communication device of the group of wireless communication devices;
forming a target group of wireless communication devices from the group of wireless communication devices, each wireless communication device of the target group of wireless communication devices having a determined location within the specified geographical area;
taking floor control of the push-to-talk communication; and
transmitting the emergency broadcast message to the group of wireless communication devices.

11. The method of claim 10, wherein transmitting the emergency broadcast message to the group of wireless communication devices includes:
transmitting the emergency broadcast message to the target group of wireless communication devices.

12. The method of claim 11, further comprising:
re-establishing the push-to-talk communication among the target group of wireless communication devices after transmitting the emergency broadcast message.

13. The method of claim 10, wherein receiving the emergency information includes receiving the emergency information from an external source, the external source being a non-party to the push-to-talk communication of the group of wireless communication devices, the external source being at least one of:
an authorized external source, and
an authenticated external source, the authenticated external source providing the emergency information after being authenticated.

14. The method of claim 10, wherein the emergency broadcast message is in a format compatible with at least one of:
a broadcast mode of a Multimedia Broadcast and Multimedia Service;
a multicast mode of a Multimedia Broadcast and Multimedia Service;
a Short Message Service; and
an Emergency Alert System.

15. A wireless communication network configured to provide a broadcast message to a group of wireless communication devices engaged in a push-to-talk communication, the wireless communication network comprising:
a push-to-talk server configured to support the push-to-talk communication among the group of wireless communication devices;
a broadcast information receiver coupled to the push-to-talk server, the broadcast information receiver configured to receive broadcast information;
a broadcast information processor coupled to the push-to-talk server and to the broadcast information receiver, the broadcast information processor configured to process the broadcast information into the broadcast message;
a floor controller coupled to the push-to-talk server, the floor controller configured to take a floor control of the push-to-talk communication; and
a transmitter coupled to the push-to-talk server and to the emergency information processor, the transmitter configured to transmit the emergency broadcast message to the group of wireless communication devices.

16. The wireless communication network of claim 15, further comprising:
a terminal identifier coupled to the push-to-talk server, the terminal identifier configured to identify the group of wireless communication devices; and
a target group constructor coupled to the terminal identifier and to the push-to-talk server, the target group constructor configured to form a target group of wireless communication devices within the group of wireless communication devices based upon target group information contained in the broadcast information,
wherein the transmitter is further configured to transmit the broadcast message to the target group of wireless communication devices.

17. The wireless communication device of claim 16, wherein the transmitter is further configured to transmit a separate broadcast message to a non-target group wireless communication devices of the group of wireless communication devices.

18. The wireless communication network of claim 15, wherein the floor controller is further configured to re-establishing the push-to-talk communication among the group of wireless communication devices after the emergency broadcast message is transmitted.

19. The wireless communication network of claim 15, further comprising:
a source authenticator coupled to the broadcast information receiver, the source authenticator configured to determine whether a source providing the broadcast information is an authorized source.

20. The wireless communication network of claim 15, wherein the broadcast message is in a format compatible with at least one of:
a broadcast mode of a Multimedia Broadcast and Multimedia Service;
a multicast mode of a Multimedia Broadcast and Multimedia Service;
a Short Message Service; and
an Emergency Alert System.
